(19) United States
(12) Patent Application Publication
(10) Pub. No.: US 2012/0057854 A1
(43) Pub. Date: Mar. 8, 2012

(54) K RATE FAST-FORWARDING AND BACKWARDING MECHANISM FOR DIGITAL VIDEOS

(76) Inventors: Ching-Lung CHANG, Touliu (TW); Ssu-Ping Huang, Touliu (TW)

(21) Appl. No.: 12/876,353

(22) Filed: Sep. 7, 2010

(51) Int. Cl. H04N 5/783; H04N 5/76

(52) U.S. Cl. 386/345; 386/E05.001

(57) ABSTRACT

A K rate fast-forwarding and backwarding mechanism for digital videos comprises a video including a plurality of Group of Pictures (GOP). Each GOP has an I frame and plural P frames. The video defines a plurality of rounds at the time that the video plays at a rate. Each round contains at least one GOP. The number of the GOP included in the round is decided in accordance with a group of classified rules composed of at least one classified rule. Thereby, a group of playing rules composed of at least one playing rule is adopted to play. Thus, a complete VCR function is achieved, which concurrently attains a smooth playing operation.

### BACKGROUND OF THE INVENTION

1. Field of the Invention

The present invention relates to a K rate fast-forwarding and backwarding mechanism for digital videos.

2. Description of the Related Art

With respect to the general application of the Internet, today there is a part of the Internet Service Provider (ISP) providing a Video on Demand in the Internet system of the Client-Server Structure. The related operating principle mainly utilizes an interactive interface in the Internet System for the client to randomly select one of the videos offered from a video catalogue at an access end (e.g. file server). Generally, the most common commands used in the Video on Demand are Play, Stop, Fast Forward, and Fast Backward. Thereby, nowadays many related manufacturers are devoted to add afore functions on the digital video system.

Today's fast-forwarding and backwarding techniques include the following means. Herein, the fast-forwarding and backwarding rate is supposed to be V:

1. Frames to be played per second (fps) are increased to V rate. For example, when 30 video frames are played per second, and the fast-forwarding and backwarding rate adopts 2 times, the frames to be played per second are 60 (30×2). Other fast-forwarding and backwarding rates are analogically applied with the same means.

2. A skip play means is applied; namely, partial frames are drawn for playing. For example, when the fast-forwarding and backwarding rate adopts 2 times, only the first frame of every two frames needs to be played, and the other frame is skipped. Other fast-forwarding and backwarding rates are analogically applied with the same means.

Although afore playing means is able to achieve the same fast-forwarding and backwarding function to that of a video player, the first means requires the hardware and the Internet environment of a higher level. Moreover, human eyes have a limited sensitivity to the changing pictures.

### SUMMARY OF THE INVENTION

The K rate fast-forwarding and backwarding mechanism for digital videos comprises a video including a plurality of Groups of Pictures (GOP). Each GOP has an I Frame and a plurality of P Frames. The video defines a plurality of rounds at the time that said video plays at a rate. Each round includes at least one GOP. A number of the GOP contained in the round is decided in accordance with a group of classified rules composed of at least one classified rule. A group of playing rules composed of at least one playing rule is adopted for a playing operation.

Thereby, the waiting time after operated is decreased. Moreover, the K rate fast-forwarding and backwarding mechanism for digital videos of the present invention further includes playing means of Fast-forward and Fast-backward.

### BRIEF DESCRIPTION OF THE DRAWINGS

FIG. 1 is a schematic view showing a Fast-forwarding operation to frames of the present invention; and

FIG. 2 is a schematic view showing a Fast-backwarding operation to frames of the present invention.

### DETAILED DESCRIPTION OF THE PREFERRED EMBODIMENTS

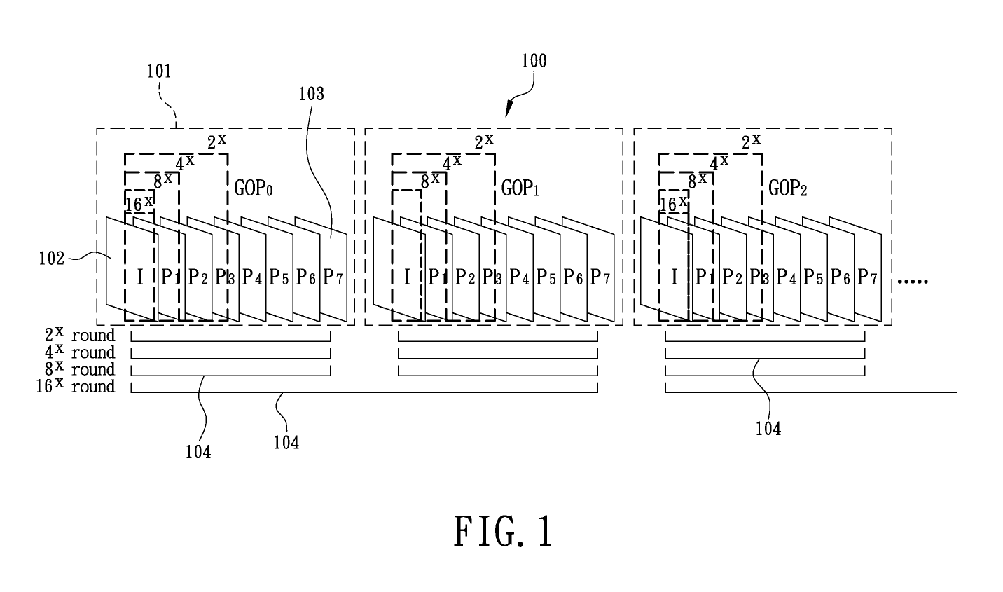

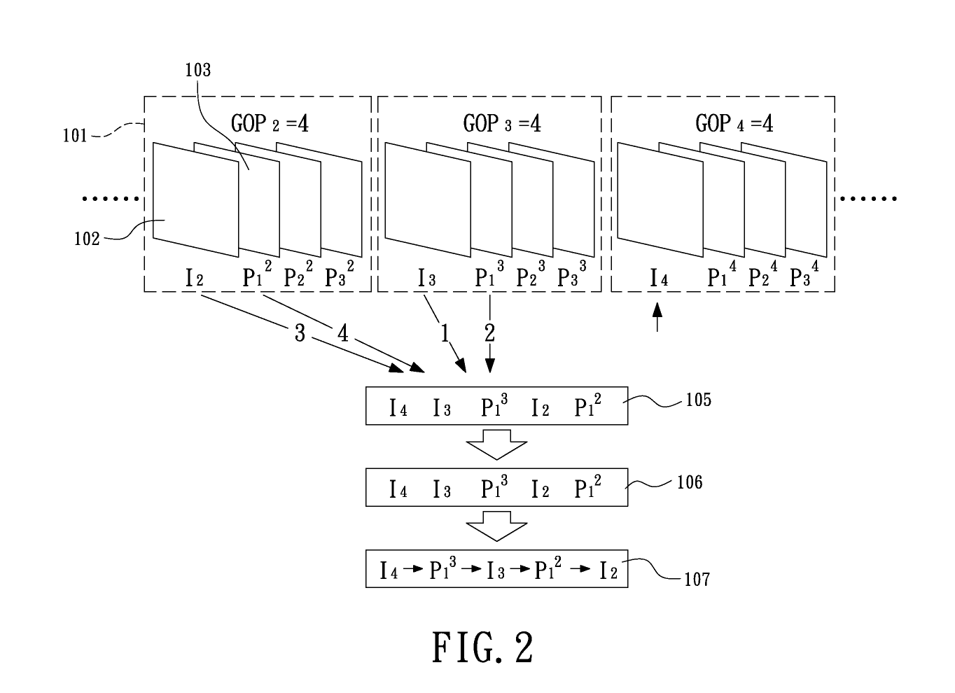

First, FIGS. 1 and 2 show schematic views of the present invention in fast forwarding and fast backwarding operations, respectively. The mechanism of the present invention could be applied to the video devices that play the digital video or be applied on the Internet. For example, Video on Demand, Internet Stream, electric appliances for digital videos, computers, cell phones, monitors, and etc. are all available.

The present invention comprises a video 100 including a plurality of Groups of Pictures (GOP) 101. Each GOP 101 has an I Frame 102 and a plurality of P Frames 103. The video 100 defines a plurality of rounds 104 at the time that the video 100 plays at a rate K. Each round 104 includes at least one GOP 101. A number of the GOP 101 contained in the round 104 is decided in accordance with a group of classified rules composed of at least one classified rule. A group of playing rules composed of at least one playing rule is adopted for a playing operation. Wherein, the group of classified rules and the group of playing rules respectively include:

1. The group of classified rules indicates that each round 104 includes a GOP 101 when the playing rate K is smaller than a frame total M of a single one of the GOP 101 and when the frame total M of the GOP 101 is directed to an integer time of the playing rate K. The group of playing rules indicates that each round 104 merely plays former W frames in light of an equation W=M/K.

2. The group of classified rules indicates that each round 104 includes N GOP 101 when the playing rate K is smaller than a frame total M of a single one of the GOP 101 and when the frame total M of the GOP 101 is not directed to an integer time of the playing rate K. The group of playing rules indicates that the video 100 selects W frames defined within the round 104 for playing. The round 104 selects former I frames within former N−1 GOP 101 to play. The N^{th} GOP 101 selects former J frames to play; wherein, equations are calculated by N=K/gcd(K,M), where gcd(K,M) is the highest common factor of K and M; W=M/gcd(K,M); I=└W/N┘; └ ┘ is directed to the Gauss function, └ ┘ is meaning for small than or equal to the most integral of x; J=(W−(N−1)×I). Further, when the number G of the GOP 101 contained in the video 100 is not an integer time of the number N of the GOP 101 contained in the round 104, a last round 104 of the video 100 merely contains Q GOP 101 in a property of Q<N. Thereby, S frames are selected within the Q GOP 101 to play, former └S/Q┘ frames are previously selected within former Q−1 GOP 101 to play, and the Q^{th} frames selects former {S−└S/Q┘(Q−1)} frames to play. Wherein, an equation is S=└Q×M/K┘.

3. The group of classified rules indicates that each round 104 includes U GOP when the playing rate K is larger than a frame total M of each GOP 101 and when the frame total M of the GOP 101 is directed to an integer time of the playing rate K. The group of playing rules indicates that each round 104 merely plays the I frame 102 in the first GOP 101 in light of an equation U=K/M.

4. The group of classified rules indicates that each round 104 includes T GOP when the playing rate K is larger than a frame total M of each GOP 101 and when the frame total M of the GOP 101 is not directed to an integer time of the playing rate K. The group of playing rules indicates that the video 100 selects X frames from the round 104 to play, and the round 104 merely selects the I frame 102 within the K^{th} GOP 101 to play; wherein, T=K/gcd(K,M), where gcd(K,M) is the highest common factor of K and M; X=M/gcd(K,M); V=O×P; P=└T/X┘; └ ┘ is directed to the Gauss function; O=1, 2 . . . , X. Further, when the number G of the GOP 101 contained in the video 100 is not an integer time of the number T of the GOP 101 contained in the round 104, a last round 104 of the video 100 merely contains R GOP 101 in a property of R<T. Thereby, Y frames are selected within the R GOP 101 to play, and the I frame 102 within the Lth GOP 101 is selected to play; wherein, Y=└R×M/K┘, L=A×B, B=└R/Y┘, A=1, 2 . . . , Y.

Referring to FIG. 1, in the fast forwarding operation to the video 100, the frame total M of the GOP 101 is 8, and the playing rate K is 2. Thereby, each round 104 includes one GOP 101, and each round 104 merely plays the former 4 frames. Namely, the playing operation of the GOP 101 permits the continuing playing to be operated to the next round 104 after the I frame 102 (I) and the P frames 103 (P1, P2, P3) are finished being played. The rest may be deduced by analogy. In addition, when the playing rate K is 16, each round 104 includes two GOP 101, and each round 104 merely plays the I frame 102 of the first GOP 101. Other playing rules may be deduced by analogy and are thereby omitted.

Accompanying with FIG. 2, the Fast-backwarding operation is adopted to the video 100. Since the video is compressed in accordance with the GOP 101 unit, and the frames in the same GOP 101 is compressed in accordance with the frame at former position of the same GOP 101; thereby, the decompression of the compressed frames should sequentially start from the I frame 102. When the total frame M of the GOP 101 is 4, and the playing rate K is 2, the frames to be played are directed to the I frame 102 (I₄). Thereby in this embodiment, the I frames 102 (I₄, I₃), the P frame 103 (P₁³), the I frame 102 (I₂), and the P frame 103 (P₁²) are successively put into a Receive Buffer 105, and thence orderly decompress the frames in the Receive Buffer 105. As a result, the decompressed frames are saved in a Decoded Buffer 106. Accordingly, a Fast-backward play algorithm as follows is adopted to access the frames in the Decoded Buffer 106 to a Playback Buffer 107 for playing. Other playing rules may be deduced by analogy and are thereby omitted.

### Fast-Backward Play Algorithm

1: if (Decoded_Buffer non empty) then

### 2: A=Read(Decoded_Buffer);

3: if (A=I Frame) then
5: while (non empty of stack)
6: Pop stack to Playback_Buffer;
7: Push A to stack;
8: else
9: Push A to stack;
10: else
11: Pop stack to Playback_Buffer;

I claim:

1. A K rate fast-forwarding and backwarding mechanism for digital videos comprising:
a video including a plurality of Groups of Pictures (GOP); each GOP having an I Frame and a plurality of P Frames;
said video defining a plurality of rounds at the time that said video plays at a rate; each round including at least one GOP; a number of said GOP contained in said round being decided in accordance with a group of classified rules composed of at least one classified rule; a group of playing rules composed of at least one playing rule being adopted for a playing operation.

2. The mechanism as claimed in claim 1, wherein, said group of classified rules indicates that each round includes a GOP when the playing rate K is smaller than a frame total M of a single one of said GOP and when said frame total of said GOP is directed to an integer time of said playing rate;
said group of playing rules indicates that each round merely plays former W frames in light of an equation W=M/K.

3. The mechanism as claimed in claim 1, wherein, said group of classified rules indicates that each round includes N GOP when said playing rate K is smaller than a frame total M of a single one of said GOP and when said frame total of said GOP is not directed to an integer time of said playing rate; said group of playing rules indicates that said video selects W frames defined within said round for playing; said round selects former I frames within a former N−1 GOP to play; the N^{th} GOP selects former J frames to play; wherein, equations are calculated by N=^{K}/gcd(K,M), where gcd(K,M) is the highest common factor of K and M, W=M/gcd(K,M), I=└W/N┘, where └ ┘ is directed to the Gauss function, and J=(W−(N−1)×I).

4. The mechanism as claimed in claim 3, wherein, when said number G of said GOP contained in said video is not an integer time of said number N of said GOP contained in said round, a last round of said video merely contains Q GOP in a property of Q<N, thereby S frames are selected within said Q GOP to play, former └S/Q┘ frames are previously selected within former Q−1 GOP to play, and the Q^{th} frame selects former {S−└S/Q┘(Q−1)} frames to play, wherein an equation is S=└Q×M/K┘, where └ ┘ is directed to the Gauss function.

5. The mechanism as claimed in claim 1, wherein, said group of classified rules indicates that said video plays at a playing rate K; each round includes U GOP when said playing rate is larger than a frame total M of each GOP and when said frame total of said GOP is directed to an integer time of said playing rate; said group of playing rules indicates that each round merely plays said I frame in the first GOP in light of an equation U=K/M.

6. The mechanism as claimed in claim 1, wherein, said group of classified rules indicates that said video is played in accordance with a playing rate K; each round includes T GOP when said playing rate is larger than a frame total M of each GOP and when said frame total of said GOP is not directed to an integer time of said playing rate; said group of playing rules indicates that said video selects X frames from said round to play, and said round merely selects said I frame within the K^{th} GOP to play; wherein, equations are calculated by T=K/gcd(K,M), where gcd(K,M) is the highest common factor of K and M, X=M/gcd(K,M), as well as V=O×P, where P=└T/X┘, └ ┘ is directed to the Gauss function, and O=1, 2, . . . X.

7. The mechanism as claimed in claim 6, wherein, when said number G of said GOP contained in said video is not an integer time of said number T of said GOP contained in said round, a last round of said video merely contains R GOP in a property of R<T, thereby Y frames are selected within said R GOP to play, and said I frame within the L^{th} GOP is selected to play; wherein, Y=└R×M/K┘, L=A×B, B=└R/Y┘, A=1, 2 . . . , Y, and └ ┘ is directed to the Gauss function.
